(19) United States
(12) Patent Application Publication
(10) Pub. No.: US 2025/0287314 A1
(43) Pub. Date: Sep. 11, 2025

(54) SYSTEMS, METHODS, AND DEVICES FOR ENHANCED SHORT DATA TRANSMISSION (SDT)

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Saratoga, CA (US)

(21) Appl. No.: 18/860,065

(22) PCT Filed: Apr. 25, 2022
(86) PCT No.: PCT/CN2022/089041

§ 371 Date: Oct. 25, 2024

(51) Int. Cl. H04W 52/02; H04B 17/318; H04W 56/00; H04W 64/00

(52) U.S. Cl. CPC H04W 52/028; H04B 17/328; H04W 56/0045; H04W 64/00

(57) ABSTRACT

Techniques, described herein, include solutions for enabling implementation of radio resource management (RRM) relaxation and short data transmission (SDT) in user equipment (UE), including reduced capacity (redcap) UE. In some implementations, RRM relaxation may be terminated during SDT; RRM relaxation may be paused during actual SDT transmission; RRM relaxation be implemented during SDT based on one or more RRM relaxation conditions; RRM relaxation may be implemented for only certain carriers during SDT; etc.

### FIELD

This disclosure relates to wireless communication networks including techniques for reduced power usage during device inactivity.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes enabling user equipment (UE) engage in radio resource management (RRM) at appropriate time and in appropriate ways.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example process for radio resource management (RRM) relaxation.

FIG. 3 is a diagram of an example process for short data transmit (SDT).

FIG. 4 is a diagram of an example process for timing advance (TA) validation and SDT initialization.

FIGS. 5-9 are diagrams of example processes for enhanced SDT and RRM according to one or more implementations described herein.

FIG. 10 is a diagram of an example of components of a device according to one or more implementations described herein.

FIG. 11 is a diagram of example interfaces of baseband circuitry according to one or more implementations described herein.

FIG. 12 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity. For example, a UE and base station may implement radio resource management (RRM) that may involve management of co-channel interference, radio resources, and other radio transmission characteristics. RRM may involve processes for controlling parameters such as transmit power, user allocation, beamforming, data rates, handover criteria, modulation scheme, error coding scheme, etc. An objective of RRM may be to utilize the limited radio-frequency spectrum resources and radio network infrastructure as efficiently as possible.

UEs may be configured to implement RRM relaxation. RRM relaxation may involve RRM processes and procedures being performed at a reduced rate or frequency. Whether a UE engages in RRM relaxation may depend on one or more conditions, such as a location of the UE (e.g., whether the UE is on the edge of a cell), the UE having a low mobility or stationary status, etc. For example, RRM may be suitable for UEs that have a strong connection to a serving base station (e.g., are not on an edge of the cell) and are stationary (e.g., not likely to move to a location where the connection will be weak). RRM relaxation may help conserve wireless resources and battery power by reducing the rate at which RRM processes and procedures are performed.

UEs may also be configured to implement small data transmission (SDT), which may include limits on the number and rate of transmissions and data that UE may send and receive from a network. When a UE transitions from an active mode to an inactive mode, the UE may receive SDT configuration information from the network. The SDT configuration information may describe how and when the UE can communicate with the network while the UE is inactive. And upon competition of a successful timing advance (TA) procedure (e.g., TA validation), the UE may communicate with the network according to the SDT configuration information.

SDT may enable data and/or signaling transmission while the UE remains in a radio resource control (RRC) inactive (e.g., RRC_INACTIVE) state. SDT may be enabled on a radio bearer basis and may be initiated by the UE when: less than a configured amount of uplink (UL) data awaits transmission across all radio bearers for which SDT is enabled; the downlink (DL) reference signal received power (RSRP) is above a configured threshold; and a valid SDT resource (either random access channel (RACH) or configured grant (CG)) is available. Similar to RRM relaxation, SDT may help conserve wireless resources and battery power by moderating (e.g., reducing) the number and/or rate of transmissions and data between the UE and network. In contrast to RRM relaxation, however, SDT may be restricted to scenarios in which the UE is inactive and has performed TA validation.

While RRM relaxation and SDT may each help conserve wireless resources and battery power, currently available telecommunication technologies fail to provide a solution resolving conflicts that may arise between simultaneous or overlapping implementations of RRM relaxation and SDT. For example, a UE implementing RRM relaxation (e.g., for being stationary and/or having a strong signal from the network) enters an inactive mode and completes TA validation, currently available telecommunication technologies fail to resolve whether/if/how RRM relaxation and SDT are implemented relative to one another. More particularly, current solutions fail to specify whether the UE implements RRM relaxation instead of SDT, SDT instead of RRM relaxation, some type of hybrid or combination of RRM relaxation and SDT, etc.

The techniques described herein include one or more solutions for implementing RRM relaxation and SDT. In some examples, RRM relaxation may be implemented until SDT is initiated (e.g., after the UE enters inactive mode and performs TA validation). In some examples, a UE may continue RRM relaxation throughout SDT but pause RRM relaxation during actual SDT transmission (Tx) and/or reception (Rx). In some examples, a UE may continue performing RRM relaxation throughout SDT but only perform RRM relaxation on different carriers (e.g., inter-frequency and inter radio access technology (inter-RAT) carrier measurements. In some examples, a UE may continue performing RRM relaxation throughout SDT so long as one or more conditions is satisfied (e.g., during a stationary or low mobility condition, UE not being located on the edge of a cell, etc.). Additionally, in some examples, the UE may implement one or more types of RRM relaxation (e.g., RRM relaxation or a reduced RRM relaxation (with longer measurement relaxation intervals)) depending on one or more conditions being satisfied. As such, the techniques described herein include a variety of solutions and alternatives to implementing RRM relaxation and SDT.

In some implementations, the techniques described herein may pertain to reduced capability (redcap) devices. A redcap device may be a UE characterized by lower device complexity, improved power consumption, and a data transmission rate no slower than a long-term evolution (LTE) category 1 (Cat-1) standard. Examples of redcap devices (or recap UEs) may include industrial sensors (e.g., pressure sensors, humidity sensors, thermometers, motion sensors, accelerometers, and actuators) surveillance cameras (e.g., of smart cities, factories, and other industrial locations) and wearable devices (e.g., smartwatches, rings, e-health related devices, and medical monitoring devices). Examples of other redcap devices may UEs with high data transmission rates, location-based service applications, sidelink (SL) capabilities, and/or both licensed and unlicensed spectrum band capabilities.

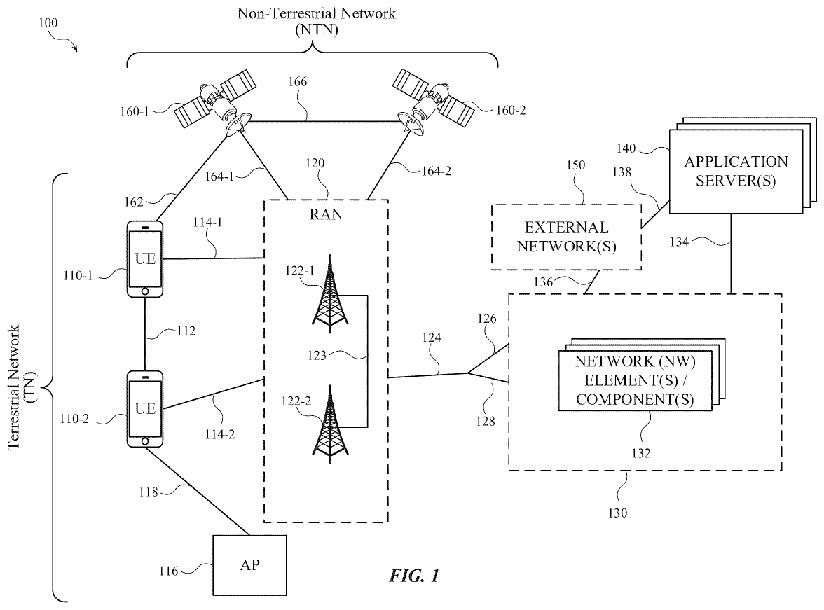

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, network 100 may include a non-terrestrial network (NTN) comprising one or more satellites 160 (e.g., of a global navigation satellite system (GNSS)) in communication with UEs 110 and RAN 120.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe), device-to-device (D2D) communications, or vehicle-to-everything (V2X) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, a V2X connection, etc. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells. As described below, in some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and also to implementation where the base station, RAN node 122, etc., is a non-terrestrial network node (e.g., satellite 160).

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VoIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

Additionally, or alternatively, satellite 160 may include a GEO satellite, LEO satellite, or another type of satellite. Satellite 160 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 160 may operate as bases stations (e.g., RAN nodes 122) with respect to UEs 110. As such, references herein to a base station, RAN node 122, etc., may involve implementations where the base station, RAN node 122, etc., is a terrestrial network node and implementation, where the base station, RAN node 122, etc., is a non-terrestrial network node (e.g., satellite 160). As described herein, UE 110 and base station 122 may communicate with one another, via interface 114, to enable enhanced power saving techniques.

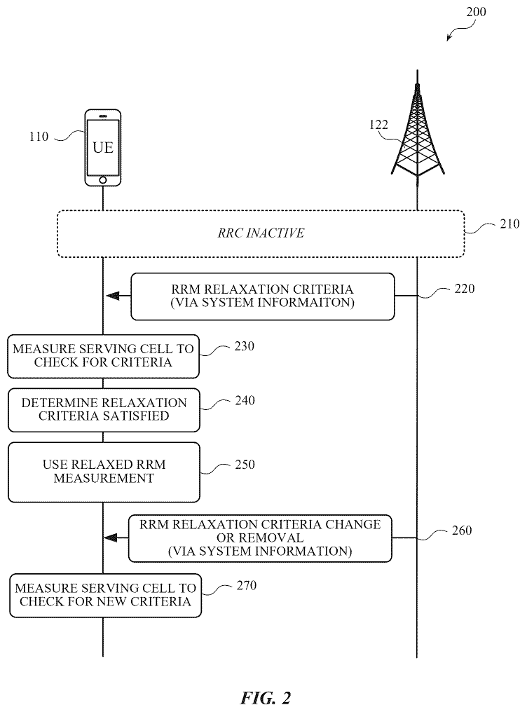

FIG. 2 is a diagram of an example process 200 for RRM relaxation. As shown in FIG. 2, in some scenarios, UE 110 may enter into an RRM relaxation mode after entering into an RRC inactive mode. In other implementations, UE 110 may enter into an RRM relaxation mode during an RRC IDLE mode. For example, UE 110 may enter into an RRM relaxation mode due to one or more conditions not relating, per se, to being in an inactive mode (such as a mobility or stationary status, whether UE 110 is located on an edge of a cell, etc.).

As shown, UE 110 may enter into an RRC inactive mode of operation (at 210). In response, or merely subsequent thereto, base station 122 may communicate RRM relaxation criteria to UE 110 via system information (at 220). UE 110 may receive the system information and measure a serving cell (e.g., signaling from base station 122) to check for RRM relaxation criteria described or indicated by the system information (at 230).

In some implementations, RRM relaxation criteria may include one or more factors, such as a mobility status of UE 110, whether UE 110 measurements a threshold level of signal strength from base station 122, and/or one or more additional or alternative conditions or criteria. In some implementations, satisfying only one of many criteria may be sufficient for UE 110 to enter RRM relaxation, while in other implementations, entering RRM relaxation may require all or a combination of one or more criteria to be satisfied.

For purposes of explaining process 200, assume that UE 110 determines that sufficient relaxation criteria is/are satisfied (at 240). As described herein, RRM may involve management of co-channel interference, radio resources, and other radio transmission characteristics. RRM may involve processes for controlling parameters such as transmit power, user allocation, beamforming, data rates, handover criteria, modulation scheme, error coding scheme, etc. An objective of RRM may be to utilize the limited radio-frequency spectrum resources and radio network infrastructure as efficiently as possible. RRM relaxation may involve RRM processes and procedures being performed selectively (e.g., limited to one or more processes and/or procedures) and/or at a reduced rate.

Additionally, whether a UE engages in RRM relaxation may depend on one or more conditions, such as a location of the UE (e.g., whether the UE is on the edge of a cell), the UE having a low mobility or stationary status, etc. For example, RRM relaxation may be suitable when UE 110 measures a strong signal strength from base station 122 (e.g., by not being located at a cell edge) and/or is stationary (e.g., not likely to move to a location whether the connection could be weak). In response, UE 110 may enter into a mode of operation for relaxed RRM measurement (at 250). In some implementations, this may include relaxed intervals or periodicity for UE 110 to perform RRM procedures.

At some point, base station 122 may communicate system information to UE 110, indicating a change in RRM relaxation criteria or removal (at 260). For example, base station 122 may increase a threshold for immobility status, low mobility status, adequate signal strength, whether one or multiple criteria is to be satisfied for RRM relaxation, etc. In response, UE 110 may remeasure the serving cell (e.g., cell of base station 122) to determine whether one or more, or an adequate number or combination of criteria are satisfied to remain in RRM relaxation (at 270). And based on the determination, remeasurement, etc., UE 110 may remain in RRM relaxation mode or exit RRM relaxation mode. As such, process 200 provides an example of how a network may enable and/or cause UE 110 to enter into and/or exit from RRM relaxation mode.

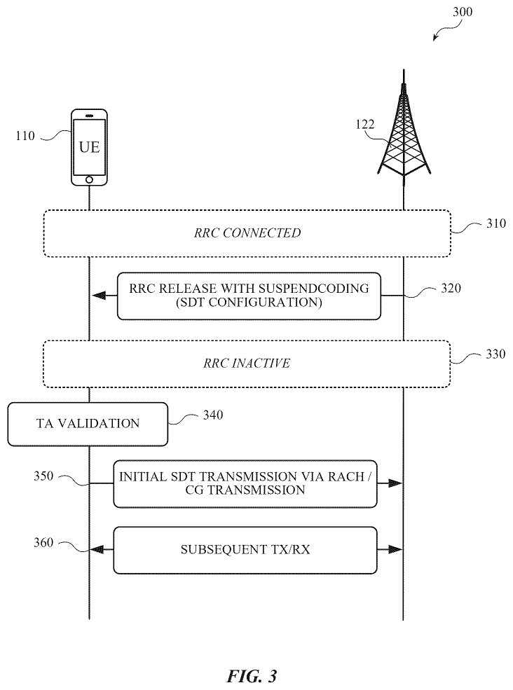

FIG. 3 is a diagram of an example process 300 for SDT. As shown, UE 110 and base station 122 may be in an RRC connected mode (at 310). At some point, UE 110 may receive information from base station 122 for RRC release with suspended coding (at 320). In some implementations, this information may include, or otherwise be received in combination with, SDT configuration information. SDT configuration information (or “SDT configuration” and the like) may include instructions, parameters, and one or more other types of information to cause, prompt, or enable UE 110 to perform SDT with respect to base station 122 or another network device.

As described herein, SDT may include a mode of operation (e.g., communicating with the network) that limits on the number and rate of transmissions and data that UE 110 may send and receive from a network. When UE 110 transitions from an active mode to an inactive mode, UE 110 may receive SDT configuration information from the network. The SDT configuration information may describe how and when the UE may communicate with the network while UE 110 is inactive. Upon competition of a successful TA procedure (e.g., TA validation), UE may communicate with the network according to the SDT configuration information.

SDT may enable data and/or signaling transmission while the UE remains in an RRC inactive (e.g., RRC_INACTIVE) state. SDT may be enabled on a radio bearer basis and may be initiated by UE 110 when for example: 1) less than a configured amount of UL data awaits transmission across all radio bearers for which SDT is enabled; 2) a DL RSRP is above a configured threshold; 3) and a valid SDT resource (either RACH or CG) is available. Similar to RRM relaxation, SDT may help conserve wireless resources and battery power by moderating (e.g., reducing) the number and/or rate of transmissions and data communicated between UE 110 and base station 122.

At some point, UE 110 may enter an RRC inactive mode (e.g., RRC_INACTIVE) (at 330). In response thereto, UE 110 may perform a TA validation procedure, which may be a prerequisite to implementing the SDT configuration information. TA validation, as described herein, may include a procedure by which UE 110 verifies a TA status of UE 110 relative to base station 122. In some implementations, TA validation may include an SDT-TA timer (SDT-TAT) base method and/or a RSRP change based method. UE 110 may initiate the SDT-TA timer based method upon receiving a TAT-SDT configuration from base station 122 (which may be received at 320 of FIG. 3). In some implementations, the SDT-TA timer may be started and/or restarted upon reception of a TA command from base station 122. A successful TA validation may result in UE 110 receiving a CG for SDT resources, and in some implementations, the CG may last until the SDT-TA timer expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) may be used for RSRP based TA validation.

For purposes of explaining example 300, assume that UE 110 successfully performs TA validation (at 340). In response to successful validation, UE 110 may send an initial SDT transmission via a RACH and/or CG resource (at 350). Whether UE 110 uses a RACH resource or a CG resource (e.g., a SDT CG resource) may depend on the SDT configuration, TA validation, and/or one or more other factors or conditions. At some point thereafter, UE 110 and base station 122 may continue using SDT for subsequent Tx/Rx communications (at 360). In this manner, UE 110 and base station 122 may implement SDT to conserve transmission resources, batter power, etc., upon UE 110 entering an RRC inactive mode and successful TA validation.

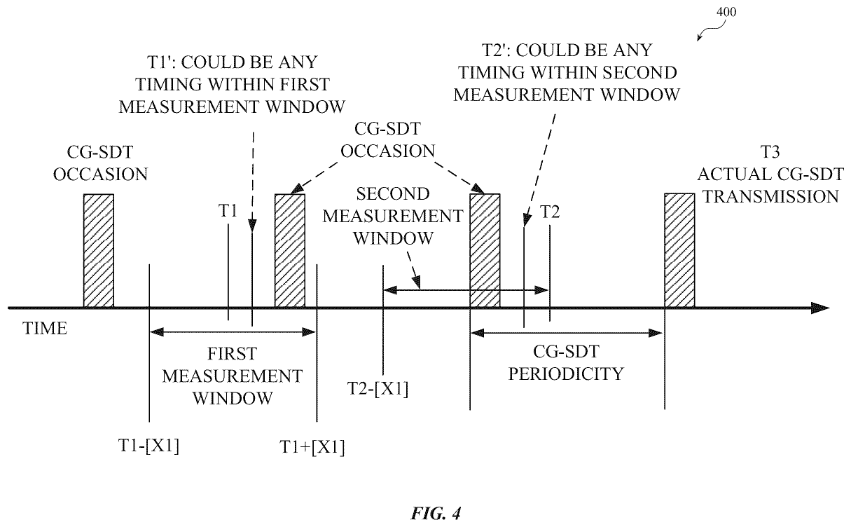

FIG. 4 is a diagram of an example process 400 for TA validation and SDT initialization. Process 400 may be implemented by UE 110. In some implementations, some or all of process 400 may be performed by one or more other systems or devices, including one or more of the devices of FIG. 1. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or process depicted in FIG. 4.

An SDT procedure may be initiated with either a transmission over RACH (referred to as RA-SDT) or over Type 1 CG resources (referred to as CG-SDT). The SDT resources may be configured on an initial bandwidth part (BWP) (for both RACH and CG). RACH and CG resources for SDT may be configured on either or both of normal UL (NUL) and supplementary UL (SUL) carriers. An initial PUSCH transmission during the SDT procedure may include at least a common control channel (CCCH) message. While the SDT procedure is ongoing, if data appears in a buffer of any radio bearer not enabled for SDT, UE 110 may initiate a transmission of a non-SDT data arrival indication using a UE assistance information message to base station 122 and, if available, may include a resume cause. Base station 122 may configure UE to apply robust header compression (ROHC) continuity for SDT either when UE 110 initiates SDT in the cell where UE 110 received an RRC release and transitioned to an RRC inactive state or when UE 110 initiates SDT in a cell of its RAN-based notification area (RNA).

For RA-SDT, base station 122 may configure 2-step and/or 4-step RA resources. UE 110 in an RRC inactive state may initiate an RACH procedure and request an RRC resume together with UL SDT data/signaling. If UE 110 accesses another base station 122 (e.g., other than the last serving base station 122), the UL SDT data/signaling may be buffered at the receiving base station 122, and then the receiving base station 122 may trigger the Xn access protocol (XnAP) retrieve UE context procedure. RA-SDT may be supported with and without UE context relocation.

CG-SDT resources may be valid within the cell that UE 110 receives the previous RRC Release (e.g., only for a no cell change case). When using CG resources for initial SDT transmission, UE 110 may perform autonomous retransmission of an initial transmission if UE 110 does not receive confirmation from base station 122, and base station 122 may schedule subsequent UL transmissions using dynamic grants or they can take place on the following CG resource occasions. DL transmissions may be scheduled using dynamic assignments. UE 110 may initiate subsequent UL transmissions after reception of confirmation for an initial PUSCH transmission from base station 122. For subsequent UL transmissions, UE 110 may not initiate re-transmission over a CG-SDT resource. CG-SDT may be initiated with valid UL timing alignment. The UL timing alignment may be maintained by UE 110 based on a SDT-specific timing alignment timer configured by base station 122 via dedicated signaling and, for initial CG-SDT transmission, also by DL RSRP of configured number of highest ranked system synchronization blocks (SSBs) which are above a configured RSRP threshold. Upon expiry of an SDT-specific timing alignment timer, CG resources may be released.

An SDT procedure may be initiated by UE 110 when the following criteria are satisfied: 1) a UL available SDT data amount is less than or equal to an SDT data amount threshold; 2) DL RSRP is greater than or equal to a configured SDT RSRP threshold; and 3) a valid SDT resource is available (e.g., an RA-SDT resource or a CG-SDT resource). An SDT procedure may be initiated via transmission over an RA-SDT resource or a CG-SDT resource. For subsequent CG-SDT transmissions, UE 110 may be enabled to initiate UL data transmissions after reception of confirmation of an initial CG-SDT transmission from base station 122. Additionally, base station 122 may schedule subsequent UL/DL transmission using dynamic grants/assignments or UL transmission on a next CG resource occasion. For subsequent RA-SDT transmissions, base station 122 may schedule UL/DL transmissions using dynamic grants and assignments after completion of the RA procedure.

Referring to FIG. 4, TI may include a time when a latest TA command MAC control element transmission was obtained by UE 110 via timing advance command MAC control element. T1′ may include a time when UE 110 has completed a first RSRP measurement (e.g., RSRP1). T2 may include a time when UE 110 performs TA validation for transmission using CG-SDT. T2′ may include a time when UE 110 has completed a second RSRP measurement (e.g., RSRP2). TA validation may include an SDT TA timer (SDT-TATimer or SDT-TAT) based method, where a TA timer may be started upon receiving a SDT-TAT configuration from base station 122 and restarted upon reception of a TA command from base station 122. Upon TA timer expiration, UE 110 may release CG-SDT resources. TA validation may also include an RSRP change based method, where UE 110 may determine a UL TA is invalid when a change in RSRP that is greater than a threshold. Additionally, a highest number (N) of SSBs of all SSBs actually transmitted as indicated in SIB1 may be used for RSRP base TA validation.

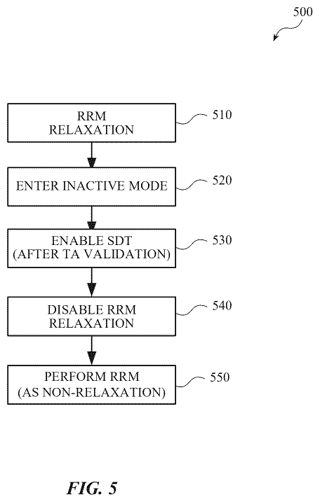

FIGS. 5-9 are diagrams of example processes 500-900 (referred to collectively as processes 500-900, and individually as process 500, 600, 700, 800, or 900) for enhanced SDT and RRM according to one or more implementations described herein. One or more of processes 500-900 may be implemented by UE 110. In some implementations, some or all of processes 500-900 may be performed by one or more other systems or devices, including one or more of the devices of FIG. 1, such as base station 122. Additionally, processes 500-900 may include one or more fewer, additional, differently ordered and/or arranged operations than those shown in FIGS. 5-9. In some implementations, some or all of the operations of any of processes 500-900 may be performed independently, successively, simultaneously, etc., of one or more of the other operations of any of processes 500-900.

Additionally, while RRM relaxation may be depicted as preceding one or more other operations (e.g., entering inactive mode), RRM relaxation may also, or alternatively be initiated or performed at one or more other times, such as after entering inactive mode, enabling SDT, etc.). As such, the techniques described herein are not limited to a number, sequence, arrangement, timing, etc., of the operations or process depicted in FIG. 4. Furthermore, the techniques described herein include corresponding operations that may be performed by one or more devices (e.g., a device that sends or communicates information to a device receiving the information). Thus, the scope of processes 500-900 include corresponding and/or supporting operations performed by other devices for purposes of implementations within, for example, the environment described above with reference to FIG. 1.

Referring to FIG. 5, process 500 may include RRM relaxation (block 510). For example, UE 110 may initiate RRM relaxation in response to one or more conditions or scenarios. As described herein, such a condition or scenario may include a mobility status of UE 110, such as UE 110 being stationary, having mobility below a pre-selected threshold, etc. Another (or alternative) condition may include a measured signal strength being at or below a pre-selected threshold, a location of UE 110 within a cell, etc. As described herein, a RRM relaxation mode may involve a mode of operations wherein UE 110 performs RRM measurements, communications, and/or other RRM operations at a reduced degree of priority, frequency, etc.

Process 500 may include entering an inactive mode (block 520). For example, UE 110 may enter an inactive mode. The inactive mode may include an RRC inactive mode, which may be triggered by one or more of the known or pre-selected conditions corresponding thereto. Entering an inactive mode may enable or facilitate UE 110 to operate on a different set of conditions, parameters, schedules, etc., in order to utilize wireless resources, expend battery power, etc., in a manner more commensurate with the UE 110 being relatively unactive.

Process 500 may include enabling SDT (block 530). For example, UE 110 may enter into an SDT mode after or upon entering an inactive mode (e.g., an RRC inactive mode). Prior to, or in combination with, entering SDT, process 500 may also, or alternatively, include performing TA validation. As described herein, TA validation may include a procedure by which UE 110 may verify a TA status of UE 110 relative to base station 122. In some implementations, TA validation may include an SDT-TA timer (SDT-TAT) based method and/or a RSRP change based method. UE 110 may initiate the SDT-TAT based method upon receiving an SDT TA timer configuration from base station 122 (which may be received at 320 of FIG. 3). In some implementations, the SDT-TAT may be started and/or restarted upon reception of a TA command from base station 122. A successful TA validation may result in UE 110 receiving a CG for SDT resources, and in some implementations, the CG may last until the SDT-TAT expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) used for RSRP based TA validation.

Process 500 may include disabling RRM relaxation (block 540). For example, UE 110 may disable RRM relaxation (initiated previously in, for example, block 510) as a result of enabling SDT. In such implementations, UE 110 may be configured to enable SDT and RRM relaxation exclusively, such that when SDT is enabled, if/when RRM relaxation is also enabled, RRM relaxation is to be disabled. Such a configuration and/or implementation may be designed, therefore, to implement SDT and RRM relaxation with exclusivity, giving SDT priority over RRM relaxation.

Process 500 may include performing RRM (block 550). For example, upon disabling RRM relaxation because of SDT enablement, UE 110 may begin, initiative, and/or otherwise perform RRM (e.g., a non-relaxation, default, standard, or legacy RRM). For instance, for implementations, where SDT enablement is prioritized exclusively over RRM, UE 110 may be configured to disable RRM relaxation during SDT enablement and revert to legacy (e.g., normal, default, etc., RRM procedures). In doing so, UE 110 may enable the performance of communications via SDT without entirely foregoing the benefits of RRM procedures.

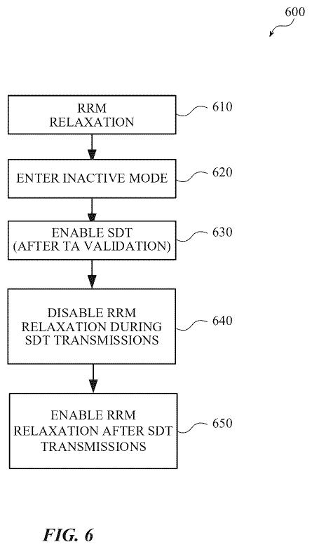

Referring to FIG. 6, process 600 may include RRM relaxation (block 610). For example, UE 110 may initiate RRM relaxation in response to one or more conditions or scenarios. As described herein, such a condition or scenario may include a mobility status of UE 110, such as UE 110 being stationary, having mobility below a pre-selected threshold, etc. Another (or alternative) condition may include a measured signal strength being at or below a pre-selected threshold, a location of UE 110 within a cell, etc. As described herein, a RRM relaxation mode may involve a mode of operations wherein UE 110 performs RRM measurements, communications, and/or other RRM operations at a reduced degree of priority, frequency, etc.

Process 600 may include entering an inactive mode (block 620). For example, UE 110 may enter an inactive mode. The inactive mode may include an RRC inactive mode, which may be triggered by one or more of the known or pre-selected conditions corresponding thereto. Entering an inactive mode may enable or facilitate UE 110 to operate on a different set of conditions, parameters, schedules, etc., in order to utilize wireless resources, expend battery power, etc., in a manner more commensurate with the UE 110 being relatively unactive.

Process 600 may include enabling SDT (block 630). For example, UE 110 may enter into an SDT mode after or upon entering an inactive mode (e.g., an RRC inactive mode). Prior to, or in combination with, entering SDT, process 600 may also, or alternatively, include performing TA validation (not shown). As described herein, TA validation may include a procedure by which UE 110 may verify a TA status of UE 110 relative to base station 122. In some implementations, TA validation may include an SDT-TA timer (SDT-TAT) based method and/or a RSRP change based method. UE 110 may initiate the SDT-TAT based method upon receiving an SDT TA timer configuration from base station 122 (which may be received at 320 of FIG. 3). In some implementations, the SDT-TAT may be started and/or restarted upon reception of a TA command from base station 122. A successful TA validation may result in UE 110 receiving a CG for SDT resources, and in some implementations, the CG may last until the SDT-TAT expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) may be used for RSRP based TA validation.

Process 600 may also include disabling RRM relaxation during actual SDT transmissions (block 640). For example, UE 110 may receive a grant or otherwise reserve SDT resources for SDT transmissions to and from base station 122. UE 110 may disable RRM relaxation (and/or checking for RRM relaxation conditions) during SDT transmissions (e.g., SDT transmission periods) and re-enable RRM relaxation after SDT transmissions. In such implementations, even though SDT may be enabled, RRM relaxation may be implemented so long as UE 110 is not engaging in SDT transmissions. Additionally, when RRM relaxation is disabled, UE 110 may implement non-relaxation or legacy RRM operations. In such implementations, therefore, UE 110 may enable RRM relaxation before and/or after enabling SDT; however, RRM relaxation would not be performed during SDT transmissions.

Process 600 may also include enabling RRM relaxation after SDT transmissions (block 650). For example, UE 110 may disable RRM relaxation during SDT transmissions and may enable (or re-enable RRM relaxation) after SDT transmissions. As such, the techniques described herein may enable RRM relaxation to be implemented during SDT with the exclusion of during SDT transmissions.

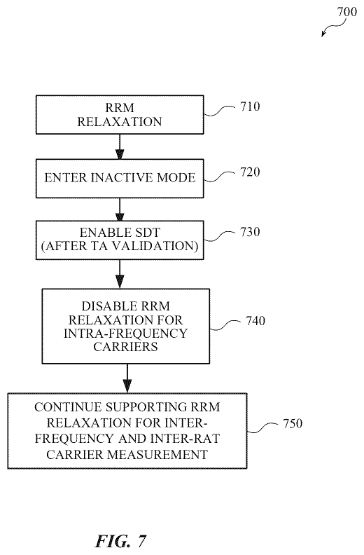

Referring to FIG. 7, process 700 may include RRM relaxation (block 710). For example, UE 110 may initiate RRM relaxation in response to one or more conditions or scenarios. As described herein, such a condition or scenario may include a mobility status of UE 110, such as UE 110 being stationary, having mobility below a pre-selected threshold, etc. Another (or alternative) condition may include a measured signal strength being at or below a pre-selected threshold, a location of UE 110 within a cell, etc. As described herein, a RRM relaxation mode may involve a mode of operations wherein UE 110 performs RRM measurements, communications, and/or other RRM operations at a reduced degree of priority, frequency, etc.

Process 700 may include entering an inactive mode (block 720). For example, UE 110 may enter an inactive mode. The inactive mode may include an RRC inactive mode, which may be triggered by one or more of the known or pre-selected conditions corresponding thereto. Entering an inactive mode may enable or facilitate UE 110 to operate on a different set of conditions, parameters, schedules, etc., in order to utilize wireless resources, expend battery power, etc., in a manner more commensurate with the UE 110 being relatively unactive.

Process 700 may include enabling SDT (block 730). For example, UE 110 may enter into an SDT mode after or upon entering an inactive mode (e.g., an RRC inactive mode). Prior to, or in combination with, entering SDT, process 700 may also, or alternatively, include performing TA validation. As described herein, TA validation may include a procedure by which UE 110 may verify a TA status of UE 110 relative to base station 122. In some implementations, TA validation may include an SDT-TA timer (SDT-TAT) based method and/or a RSRP change based method. UE 110 may initiate the SDT-TAT based method upon receiving an SDT TA timer configuration from base station 122 (which may be received at 320 of FIG. 3). In some implementations, the SDT-TAT may be started and/or restarted upon reception of a TA command from base station 122. A successful TA validation may result in UE 110 receiving a CG for SDT resources, and in some implementations, the CG may last until the SDT-TAT expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) may be used for RSRP based TA validation.

Process 700 may include disabling RRM relaxation for intra-frequency carriers (block 740). For example, UE 110 may disable RRM relaxation for intra-frequency carriers. In such implementations, UE 110 may perform non-relaxation or legacy RRM on intra-frequency carriers. Additionally, or alternatively, UE 110 may continue to perform RRM relaxation on inter-RAT carriers, which may include RRM relaxation condition checking and RRM measurement relaxation (block 750).

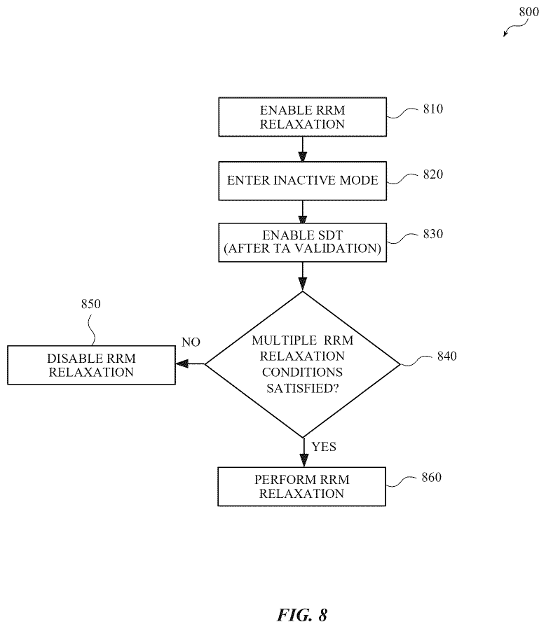

Referring to FIG. 8, process 800 may include RRM relaxation (block 810). For example, UE 110 may initiate RRM relaxation in response to one or more conditions or scenarios. As described herein, such a condition or scenario may include a mobility status of UE 110, such as UE 110 being stationary, having mobility below a pre-selected threshold, etc. Another (or alternative) condition may include a measured signal strength being at or below a pre-selected threshold, a location of UE 110 within a cell, etc. As described herein, a RRM relaxation mode may involve a mode of operations wherein UE 110 performs RRM measurements, communications, and/or other RRM operations at a reduced degree of priority, frequency, etc.

Process 800 may include entering an inactive mode (block 820). For example, UE 110 may enter an inactive mode. The inactive mode may include an RRC inactive mode, which may be triggered by one or more of the known or pre-selected conditions corresponding thereto. Entering an inactive mode may enable or facilitate UE 110 to operate on a different set of conditions, parameters, schedules, etc., in order to utilize wireless resources, expend battery power, etc., in a manner more commensurate with the UE 110 being relatively unactive.

Process 800 may include enabling SDT (block 830). For example, UE 110 may enter into an SDT mode after or upon entering an inactive mode (e.g., an RRC inactive mode). Prior to, or in combination with, entering SDT, process 800 may also, or alternatively, include performing TA validation. As described herein, TA validation may include a procedure by which UE 110 may verify a TA status of UE 110 relative to base station 122. In some implementations, TA validation may include an SDT-TA timer (SDT-TAT) based method and/or a RSRP change based method. UE 110 may initiate the SDT-TAT based method upon receiving an SDT TA timer configuration from base station 122 (which may be received at 320 of FIG. 3). In some implementations, the SDT-TAT may be started and/or restarted upon reception of a TA command from base station 122. A successful TA validation may result in UE 110 receiving a CG for SDT resources, and in some implementations, the CG may last until the SDT-TAT expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) may be used for RSRP based TA validation.

Process 800 may include determining whether multiple RRM relaxation conditions are satisfied (block 840). For example, after enabling SDT, UE 110 may determine whether multiple RRM relaxation conditions are satisfied. Examples of such conditions may include any combination of a stationary status of UE 110, a mobility status of UE 110 (e.g., whether the UE is in a low mobility state), whether UE 110 is located at an edge of serving cell according to one or more cell edge standards, etc. Whether UE 110 is located at an edge of serving cell may include the RSRP received strength of serving cell is above a certain threshold X. Additionally, or alternatively, whether UE 110 is located at an edge of serving cell may include the RSRP received strength is above a certain threshold Y, and Y may be greater than or equal to X. In some implementations, UE 110 may be considered as being located at the edge of serving cell when multiple definitions of being at the edge of serving cell are satisfied.

When the selected RRM relaxation conditions are not satisfied (block 840—No), UE 110 may proceed to disable RRM relaxation (block 850). In some implementations, non-relaxation or legacy RRM may be performed instead. Additionally, or alternatively, UE 110 may disable RRM relaxation for the entire SDT duration, only during SDT transmissions, and/or for only certain carriers (e.g., intra-frequency carriers). When the selected RRM relaxation conditions are satisfied (block 840—No), UE 110 may proceed to perform RRM relaxation (block 860).

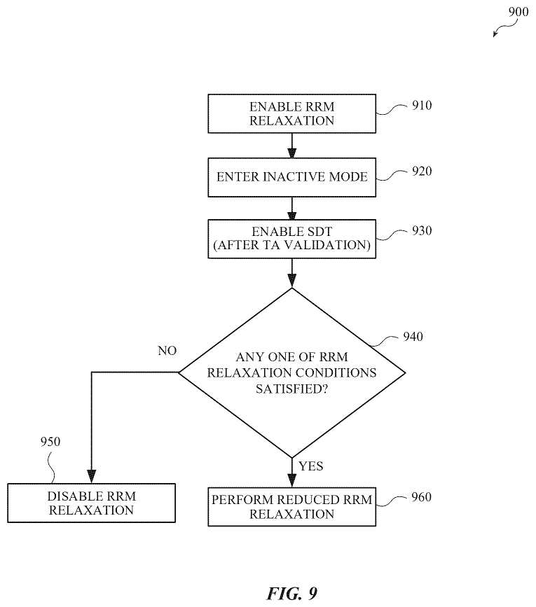

Referring to FIG. 9, process 900 may include RRM relaxation (block 910). For example, UE 110 may initiate RRM relaxation in response to one or more conditions or scenarios. As described herein, such a condition or scenario may include a mobility status of UE 110, such as UE 110 being stationary, having mobility below a pre-selected threshold, etc. Another (or alternative) condition may include a measured signal strength being at or below a pre-selected threshold, a location of UE 110 within a cell, etc. As described herein, a RRM relaxation mode may involve a mode of operations wherein UE 110 performs RRM measurements, communications, and/or other RRM operations at a reduced degree of priority, frequency, etc.

Process 900 may include entering an inactive mode (block 920). For example, UE 110 may enter an inactive mode. The inactive mode may include an RRC inactive mode, which may be triggered by one or more of the known or pre-selected conditions corresponding thereto. Entering an inactive mode may enable or facilitate UE 110 to operate on a different set of conditions, parameters, schedules, etc., in order to utilize wireless resources, expend battery power, etc., in a manner more commensurate with the UE 110 being relatively unactive.

Process 900 may include enabling SDT (block 930). For example, UE 110 may enter into an SDT mode after or upon entering an inactive mode (e.g., an RRC inactive mode). Prior to, or in combination with, entering SDT, process 900 may also, or alternatively, include performing TA validation. As described herein, TA validation may include a procedure by which UE 110 may verify a TA status of UE 110 relative to base station 122. In some implementations, TA validation may include an SDT-TA timer (SDT-TAT) based method and/or a RSRP change based method. UE 110 may initiate the SDT-TAT based method upon receiving an SDT TA timer configuration from base station 122 (which may be received at 320 of FIG. 3). In some implementations, the SDT-TAT may be started and/or restarted upon reception of a TA command from base station 122. A successful TA validation may result in UE 110 receiving a CG for SDT resources, and in some implementations, the CG may last until the SDT-TAT expires. The RSRP change based method may include UE 110 measuring an RSRP from base station 122 and determining that a TA is invalid or no longer valid if/when a change in the RSRP exceeds a pre-selected threshold. A highest number (N) of SSBs of all SSBs actually transmitted, as indicated in a system information block (e.g., SIB1) may be used for RSRP based TA validation.

Process 900 may include determining whether any one RRM relaxation condition is satisfied (block 840). For example, after enabling SDT, UE 110 may determine whether a particular RRM relaxation condition is satisfied or whether any one RRM relaxation condition, of multiple possible RRM relaxation conditions, is satisfied. Examples of such conditions may include any combination of a stationary status of UE 110, a mobility status of UE 110 (e.g., whether the UE is in a low mobility state), whether UE 110 is located at an edge of serving cell according to one or more cell edge standards, etc. Whether UE 110 is located at an edge of serving cell may include the RSRP received strength of serving cell is above a certain threshold X. Additionally, or alternatively, whether UE 110 is located at an edge of serving cell may include the RSRP received strength is above a certain threshold Y, and Y may be greater than or equal to X.

When an RRM relaxation condition is not satisfied (block 940—No), UE 110 may proceed to disable RRM relaxation (block 950). In some implementations, non-relaxation or legacy RRM may be performed instead. Additionally, or alternatively, UE 110 may disable RRM relaxation for the entire SDT duration, only during SDT transmissions, and/or for only certain carriers (e.g., intra-frequency carriers). When the selected RRM relaxation conditions are satisfied (block 940—No), UE 110 may proceed to perform RRM relaxation (block 960).

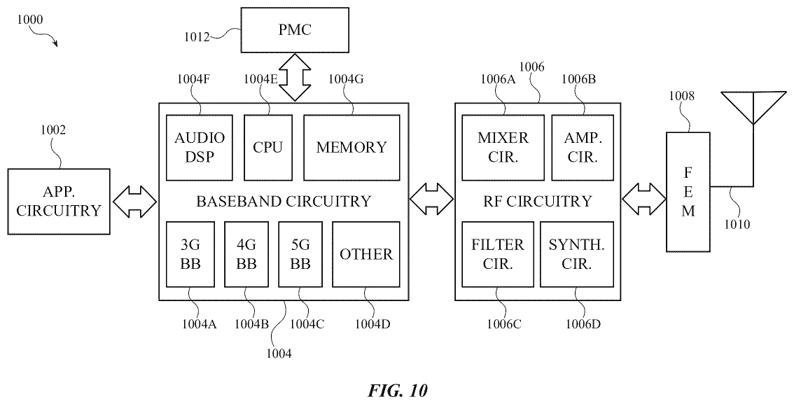

FIG. 10 is a diagram of an example of components of a device according to one or more implementations described herein. In some implementations, the device 1000 can include application circuitry 1002, baseband circuitry 1004, RF circuitry 1006, front-end module (FEM) circuitry 1008, one or more antennas 1010, and power management circuitry (PMC) 1012 coupled together at least as shown. The components of the illustrated device 1000 can be included in a UE or a RAN node. In some implementations, the device 1000 can include fewer elements (e.g., a RAN node may not utilize application circuitry 1002, and instead include a processor/controller to process IP data received from a CN such as 5GC 130 or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuity 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 2G, 6G, etc.). The baseband circuitry 1004 (e.g., one or more of baseband processors 1004A-D) can handle various radio control functions that enable communication with one or more radio networks via the RF circuitry 1006. In other implementations, some or all of the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some implementations, modulation/demodulation circuitry of the baseband circuitry 1004 can include Fast-Fourier Transform (FFT), precoding, or constellation mapping/de-mapping functionality. In some implementations, encoding/decoding circuitry of the baseband circuitry 1004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1004 can include one or more audio digital signal processor(s) (DSP) 1004F. The audio DSPs 1004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1004 and the application circuitry 1002 can be implemented together such as, for example, on a system on a chip (SOC).

In some implementations, the baseband circuitry 1004 can provide for communication compatible with one or more radio technologies. For example, in some implementations, the baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path. In some implementations, the mixer circuitry 1006A of the receive signal path can be configured to down-convert RF signals received from the FEM circuitry 1008 based on the synthesized frequency provided by synthesizer circuitry 1006D. The amplifier circuitry 1006B can be configured to amplify the down-converted signals and the filter circuitry 1006C can be a low-pass filter (LPF) or band-pass filter (BPF) configured to remove unwanted signals from the down-converted signals to generate output baseband signals. Output baseband signals can be provided to the baseband circuitry 1004 for further processing. In some implementations, the output baseband signals can be zero-frequency baseband signals, although this is not a requirement. In some implementations, mixer circuitry 1006A of the receive signal path can comprise passive mixers, although the scope of the implementations is not limited in this respect.

In some implementations, the mixer circuitry 1006A of the transmit signal path can be configured to up-convert input baseband signals based on the synthesized frequency provided by the synthesizer circuitry 1006D to generate RF output signals for the FEM circuitry 1008. The baseband signals can be provided by the baseband circuitry 1004 and can be filtered by filter circuitry 1006C.

In some implementations, the mixer circuitry 1006A of the receive signal path and the mixer circuitry 1006A of the transmit signal path can include two or more mixers and can be arranged for quadrature down conversion and up conversion, respectively. In some implementations, the mixer circuitry 1006A of the receive signal path and the mixer circuitry 1006A of the transmit signal path can include two or more mixers and can be arranged for image rejection (e.g., Hartley image rejection). In some implementations, the mixer circuitry 1006A of the receive signal path and the mixer circuitry 906A can be arranged for direct down conversion and direct up conversion, respectively. In some implementations, the mixer circuitry 1006A of the receive signal path and the mixer circuitry 1006A of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 1006 can include analog-to-digital converter (ADC) and digital-to-analog converter (DAC) circuitry and the baseband circuitry 1004 can include a digital baseband interface to communicate with the RF circuitry 1006.

In some dual-mode implementations, a separate radio IC circuitry can be provided for processing signals for each spectrum, although the scope of the implementations is not limited in this respect.

In some implementations, the synthesizer circuitry 1006D can be a fractional-N synthesizer or a fractional N/N+1 synthesizer, although the scope of the implementations is not limited in this respect as other types of frequency synthesizers can be suitable. For example, synthesizer circuitry 1006D can be a delta-sigma synthesizer, a frequency multiplier, or a synthesizer comprising a phase-locked loop with a frequency divider.

The synthesizer circuitry 1006D can be configured to synthesize an output frequency for use by the mixer circuitry 1006A of the RF circuitry 1006 based on a frequency input and a divider control input. In some implementations, the synthesizer circuitry 1006D can be a fractional N/N+1 synthesizer.

In some implementations, frequency input can be provided by a voltage controlled oscillator (VCO), although that is not a requirement. Divider control input can be provided by either the baseband circuitry 1004 or the applications circuitry 1002 depending on the desired output frequency. In some implementations, a divider control input (e.g., N) can be determined from a look-up table based on a channel indicated by the applications circuitry 1002.

Synthesizer circuitry 1006D of the RF circuitry 1006 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by cither N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1006 can include an IQ/polar converter.

FEM circuitry 1008 can include a receive signal path which can include circuitry configured to operate on RF signals received from one or more antennas 1010, amplify the received signals and provide the amplified versions of the received signals to the RF circuitry 1006 for further processing. FEM circuitry 1008 can also include a transmit signal path which can include circuitry configured to amplify signals for transmission provided by the RF circuitry 1006 for transmission by one or more of the one or more antennas 1010. In various implementations, the amplification through the transmit or receive signal paths can be done solely in the RF circuitry 1006, solely in the FEM circuitry 1008, or in both the RF circuitry 1006 and the FEM circuitry 1008.

In some implementations, the FEM circuitry 1008 can include a Tx/Rx switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1006). The transmit signal path of the FEM circuitry 1008 can include a power amplifier (PA) to amplify input RF signals (e.g., provided by RF circuitry 1006), and one or more filters to generate RF signals for subsequent transmission (e.g., by one or more of the one or more antennas 1010).

In some implementations, the PMC 1012 can manage power provided to the baseband circuitry 1004. In particular, the PMC 1012 can control power-source selection, voltage scaling, battery charging, or DC-to-DC conversion. The PMC 1012 can often be included when the device 1000 is capable of being powered by a battery, for example, when the device is included in a UE. The PMC 1012 can increase the power conversion efficiency while providing desirable implementation size and heat dissipation characteristics.

While FIG. 10 shows the PMC 1012 coupled only with the baseband circuitry 1004. However, in other implementations, the PMC 1012 may be additionally or alternatively coupled with, and perform similar power management operations for, other components such as, but not limited to, application circuitry 1002, RF circuitry 1006, or FEM circuitry 1008.

In some implementations, the PMC 1012 can control, or otherwise be part of, various power saving mechanisms of the device 1000. For example, if the device 1000 is in an RRC_Connected state, where it is still connected to the RAN node as it expects to receive traffic shortly, then it can enter a state known as Discontinuous Reception Mode (DRX) after a period of inactivity. During this state, the device 1000 can power down for brief intervals of time and thus save power.

If there is no data traffic activity for an extended period of time, then the device 1000 can transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1002 and processors of the baseband circuitry 1004 can be used to execute elements of one or more instances of a protocol stack. For example, processors of the baseband circuitry 1004, alone or in combination, can be used execute Layer 3,Layer 2, or Layer 1 functionality, while processors of the baseband circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

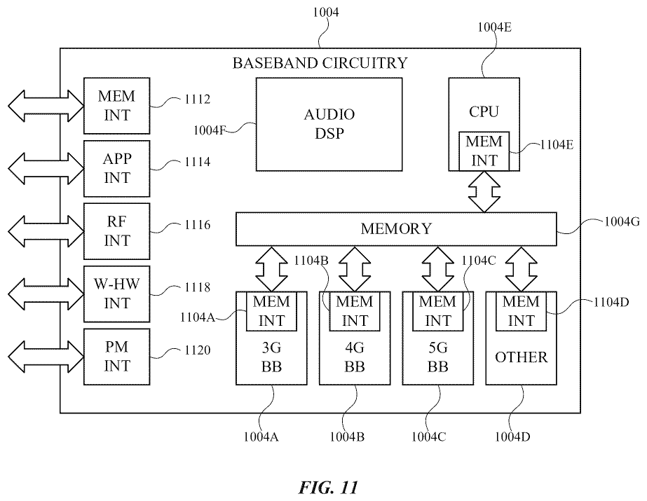

FIG. 11 is a diagram of example interfaces of baseband circuitry according to one or more implementations described herein. As discussed above, the baseband circuitry 1004 of FIG. 10 can comprise processors 1004A-E and a memory 1004G utilized by said processors. Each of the processors 1004A-E can include a memory interface, 1104A-E, respectively, to send/receive data to/from the memory 1004G.

The baseband circuitry 1004 can further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1109 (e.g., an interface to send/receive power or control signals to/from the PMC 1012).

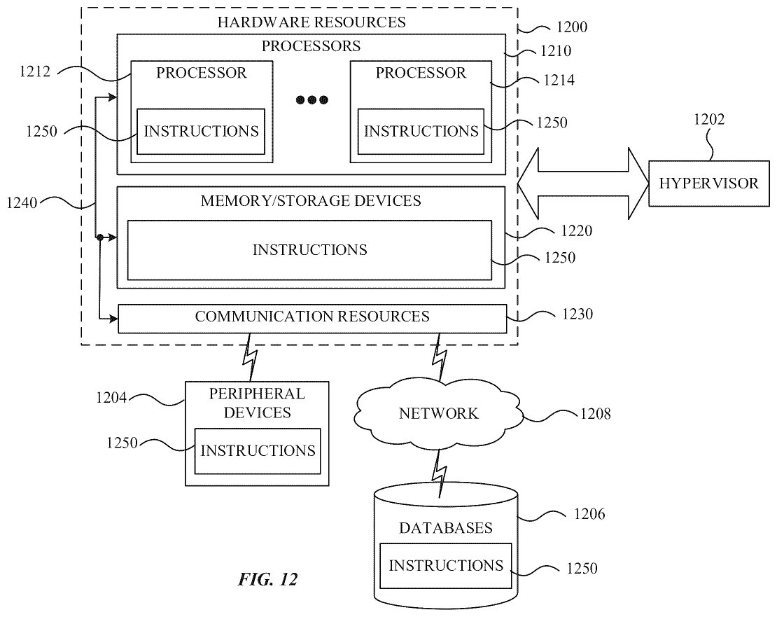

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240. For embodiments where node virtualization (e.g., NFV) is utilized, a hypervisor 1202 may be executed to provide an execution environment for one or more network slices/sub-slices to utilize the hardware resources 1200

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1212 and a processor 1214.

The memory/storage devices 1220 may include main memory, disk storage, or any suitable combination thereof. The memory/storage devices 1220 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1230 may include interconnection or network interface components or other suitable devices to communicate with one or more peripheral devices 1204 or one or more databases 1206 via a network 1208. For example, the communication resources 1230 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a baseband processor of a user equipment (UE) may comprise: one or more processors configured to: enter an inactive mode of operation; determine, during the inactive mode, whether the UE is configured for small data transmission (SDT); when the UE is not configured for SDT, perform radio resource management (RRM) relaxation; and when the UE is configured for SDT, perform RRM relaxation based on the SDT.

In example 2, which may also include one or more of the examples described herein, performing RRM relaxation based on the SDT comprises refraining from performing RRM relaxation when the UE is configured for SDT. In example 3, which may also include one or more of the examples described herein, performing RRM relaxation based on the SDT comprises refraining from performing RRM relaxation during SDT transmissions. In example 4, which may also include one or more of the examples described herein, performing RRM relaxation based on the SDT comprises refraining from performing RRM relaxation for one or more pre-selected frequency carriers. In example 5, which may also include one or more of the examples described herein, performing RRM relaxation based on the SDT comprises refraining from performing RRM relaxation when one or more relaxation conditions are satisfied.

In example 6, which may also include one or more of the examples described herein, the one or more relaxation conditions comprises at least one of: a location of the UE with respect to a cell perimeter; a stationary status of the UE; or a mobility status of the UE. In example 7, which may also include one or more of the examples described herein, performing RRM relaxation based on the SDT comprises refraining from performing RRM relaxation with 1-hour or more than 1-hour measurement interval. In example 8, which may also include one or more of the examples described herein, timing advance (TA) validation for SDT is satisfied when the UE is performing RRM relaxation in a low mobility mode.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, configured to, when executing instructions stored in a memory, perform operations comprising:
entering an inactive mode of operation;
determining that a user equipment (UE) is configured for small data transmission (SDT) during the inactive mode; and
in response to the determination, performing radio resource management (RRM) relaxation based on the SDT configuration.

2. The baseband processor of claim 1, wherein performing the RRM relaxation comprises refraining from performing RRM relaxation when the UE is configured for SDT.

3. The baseband processor of claim 1, wherein performing the RRM relaxation comprises refraining from performing RRM relaxation during SDT transmissions.

4. The baseband processor of claim 1, wherein performing the RRM relaxation comprises refraining from performing RRM relaxation for one or more pre-selected frequency carriers.

5. The baseband processor of claim 1, wherein performing the RRM relaxation comprises refraining from performing RRM relaxation when one or more relaxation conditions are satisfied.

6. The baseband processor of claim 5, wherein the one or more relaxation conditions comprises at least one of:
a location of the UE with respect to a cell perimeter;
a stationary status of the UE; or
a mobility status of the UE.

7. The baseband processor of claim 1, wherein performing the RRM relaxation comprises refraining from performing RRM relaxation with 1-hour or more than 1-hour measurement interval.

8. The baseband processor of claim 1, wherein timing advance (TA) validation for SDT is satisfied when the UE is performing the RRM relaxation in a low mobility mode.

9. A user equipment (UE), comprising:
radio frequency (RF) circuitry; and
one or more processors coupled to the RF circuitry and configured to execute instructions stored in a memory to cause the UE to:
enter an inactive mode of operation;
determine that the UE is configured for small data transmission (SDT) during the inactive mode; and
in response to the determination, perform radio resource management (RRM) relaxation based on the SDT configuration.

10. The UE of claim 9, wherein performing the RRM relaxation comprises refraining from performing RRM relaxation when the UE is configured for SDT.

11. The UE of claim 9, wherein performing the RRM relaxation comprises refraining from performing RRM relaxation during SDT transmissions.

12. The UE of claim 9, wherein performing the RRM relaxation comprises refraining from performing RRM relaxation for one or more pre-selected frequency carriers.

13. The UE of claim 9, wherein performing the RRM relaxation comprises refraining from performing RRM relaxation when one or more relaxation conditions are satisfied.

14. The UE of claim 13, wherein the one or more relaxation conditions comprises at least one of:
a location of the UE with respect to a cell perimeter;
a stationary status of the UE; or
a mobility status of the UE.

15. The UE of claim 9, wherein performing the RRM relaxation comprises refraining from performing RRM relaxation with a 1-hour or more than 1-hour measurement interval.

16. The UE of claim 9, wherein timing advance (TA) validation for SDT is satisfied when the UE is performing the RRM relaxation in a low mobility mode.

17. A method for a user equipment (UE) comprising:
entering an inactive mode of operation;
determining that the UE is configured for small data transmission (SDT) during the inactive mode; and
in response to the determination, performing radio resource management (RRM) relaxation based on the SDT configuration.

18. The method of claim 17, wherein performing the RRM relaxation comprises refraining from performing RRM relaxation when the UE is configured for SDT.

19. The method of claim 17, wherein performing the RRM relaxation comprises refraining from performing RRM relaxation during SDT transmissions.

20. The method of claim 17, wherein performing the RRM relaxation comprises refraining from performing RRM relaxation for one or more pre-selected frequency carriers.
